(19) United States
(12) Patent Application Publication
(10) Pub. No.: US 2022/0340784 A1
(43) Pub. Date: Oct. 27, 2022

(54) ADHERABLE FILM AND METHOD OF MANUFACTURE THEREOF

(71) Applicant: 3M INNOVATIVE PROPERTIES COMPANY, St. Paul, MN (US)

(72) Inventors: Eumi Pyun, St. Paul, MN (US); Shinsuke Kondo, Yamagata (JP); Lynn E. Lorimor, Minneapolis, MN (US)

(21) Appl. No.: 17/762,585

(22) PCT Filed: Sep. 24, 2020
(86) PCT No.: PCT/IB2020/058963

§ 371 Date: Mar. 22, 2022

Related U.S. Application Data
(60) Provisional application No. 62/905,664, filed on Sep. 25, 2019.

(51) Int. Cl. C09J 7/22

(52) U.S. Cl. CPC C09J 7/22; C09J 2301/204; C09J 2301/408; C09J 2301/41

(57) ABSTRACT

An adherable film includes a substrate that is substantially free of a flame retardant material and has a top major surface and a bottom major surface. An adhesive layer disposed on the bottom major surface of the substrate has a continuous pattern. The adhesive layer is made of an adhesive that is substantially free of a flame retardant material. In a plan view, the continuous pattern defines a plurality of discontinuous non-adhesive portions of the substrate without the adhesive. Each discontinuous non-adhesive portion is completely surrounded by the continuous pattern. The adherable film including the adhesive layer having the continuous pattern exhibits an improved flame retarding characteristic relative to a discontinuous adherable film having a substrate with a same material composition as that of the substrate of the adherable film and a discontinuous adhesive layer with a same material composition as that of the adhesive layer of the adherable film.

### TECHNICAL FIELD

The present disclosure relates generally to adherable films, and more specifically to adherable films and methods of manufacturing adherable films having improved flame retarding characteristics.

### BACKGROUND

Various safety regulations exist for stationary and mobile structures. For example, many countries have low combustibility or low flammability requirements for film products applied to surfaces in the interior or exterior of a building, such as a hotel, a school, a hospital or a restaurant. This may also be applied to a vehicle, such as a train, an automobile or an aircraft. Such requirements may help to increase safety for individuals in a particular area by decreasing likelihood of an explosion or fire spreading in the event of a spark or an ignition.

Stricter regulations are causing requirements of peak and total heat release to be extremely low. There may be various ways to bring down the peak and total heat release. One of the ways to reduce the total heat release is to lower the amount of material in the construction of the film. However, when the film or adhesive becomes too thin, it may be difficult to handle and/or adhere to surfaces. Another way is to provide the adhesive in a pattern.

FIG. 1 illustrates a prior art example of an adhesive layer 108 for an adherable film in a plan view. The adhesive layer 108 is a continuous adhesive layer without any non-adhesive portions therein. The adhesive layer 108 may have a uniform thickness throughout and extends across the adherable film. The amount of adhesive may be lowered in the adhesive layer 108 for reducing the peak and total heat release. Further, the thickness of the adhesive layer 108 may also be lowered as the adhesive is applied uniformly. However, lowering the amount and/or thickness of the adhesive below certain thresholds may render the adhesive layer 108 unable to adhere to a substrate.

FIG. 2 shows a conventional adhesive pattern in a plan view. As shown in FIG. 2, the adherable film 100 is provided with a discontinuous adhesive layer 202. The discontinuous adhesive layer 202 is substantially free of a flame retardant material. The discontinuous adhesive layer 202 has a plurality of discontinuous adhesive portions 204 spaced apart from each other. The plurality of discontinuous adhesive portions 204 may be distributed over the adherable film. In the illustrated example, the plurality of discontinuous adhesive portions 204 are shown to be arranged in multiple polygons spaced apart from each other. Each discontinuous adhesive portion 204 is completely surrounded by a non-adhesive portion of the substrate 102.

### SUMMARY

Generally, the present invention relates to adherable films. The present invention also relates to structural details of an adherable film as well as a manufacturing method of such an adherable film.

In one embodiment of the present disclosure, an adherable film is provided. The adherable film includes a substrate having a top major surface and a bottom major surface. The substrate is substantially free of a flame retardant material. The adherable film includes an adhesive layer disposed on the bottom major surface of the substrate and having a continuous pattern. The adhesive layer is made of an adhesive that is substantially free of a flame retardant material. In a plan view, the continuous pattern defines a plurality of discontinuous non-adhesive portions of the substrate without the adhesive. Each discontinuous non-adhesive portion is completely surrounded by the continuous pattern. Further, the adherable film including the adhesive layer having the continuous pattern exhibits an improved flame retarding characteristic relative to a discontinuous adherable film having a substrate with a same material composition as that of the substrate of the adherable film and a discontinuous adhesive layer with a same material composition as that of the adhesive layer of the adherable film. The discontinuous adhesive layer has a same mass of the adhesive as that of the adhesive layer of the adherable film and has a plurality of discontinuous adhesive portions spaced apart from each other.

In some embodiments, a total heat release (THR) of the adherable film with the adhesive layer is less than or equal to 8.0 megajoule/square meter (MJ/m²).

In some embodiments, the flame retarding characteristic is defined based on at least one of a total heat release (THR), a peak heat release rate (HRR) and a fire growth rate (FIGRA).

In some embodiments, a THR of the adherable film with the continuous pattern is lower than a THR of the discontinuous adherable film.

In some embodiments, a peak HRR of the adherable film with the continuous pattern is lower than a peak HRR of the discontinuous adherable film.

In some embodiments, a FIGRA of the adherable film with the continuous pattern is lower than a FIGRA of the discontinuous adherable film.

In some embodiments, a width of each discontinuous non-adhesive portion is greater than or equal to 0.5 mm and less than or equal to 1 cm.

In some embodiments, a thickness of the adhesive layer is from about 12.7 microns to about 76.2 microns.

In some embodiments, each discontinuous non-adhesive portion has a polygonal shape.

In some embodiments, each discontinuous non-adhesive portion has a same area.

In some embodiments, each discontinuous non-adhesive portion has a square shape.

In another embodiment, a method of manufacturing an adherable film is provided. The method includes providing a substrate having a top major surface and a bottom major surface. The substrate is substantially free of a flame retardant material. The method includes forming an adhesive layer in a continuous pattern on the bottom major surface of the substrate. The adhesive layer is made of an adhesive that is substantially free of a flame retardant material. In a plan view, the continuous pattern defines a plurality of discontinuous non-adhesive portions of the substrate without the adhesive. Each discontinuous non-adhesive portion is completely surrounded by the continuous pattern. Further, the adherable film with the adhesive layer having the pattern exhibits an improved flame retarding characteristic relative to a discontinuous adherable film having a substrate with a same material composition as that of the substrate of the adherable film and a discontinuous adhesive layer with a same material composition as that of the adhesive layer of the adherable film. The discontinuous adhesive layer has a same mass of the adhesive as that of the adhesive layer of the adherable film and has a plurality of discontinuous adhesive portions spaced apart from each other.

In another embodiment, an adherable film is provided. The adherable film includes a substrate having a top major surface and a bottom major surface. The substrate is substantially free of a flame retardant material. The adherable film includes an adhesive layer disposed on the bottom major surface of the substrate and having a continuous pattern. The adhesive layer is made of an adhesive that is substantially free of a flame retardant material. In a plan view, the continuous pattern defines a plurality of discontinuous non-adhesive portions of the substrate without the adhesive. Each discontinuous non-adhesive portion is completely surrounded by the continuous pattern. The adherable film with the adhesive layer having the pattern has a lower total heat release rate (THR) relative to a discontinuous adherable film having a substrate with a same material composition as that of the substrate of the adherable film and a discontinuous adhesive layer with a same material composition as that of the adhesive layer of the adherable film. The discontinuous adhesive layer has a same mass of the adhesive as that of the adhesive layer of the adherable film and has a plurality of discontinuous adhesive portions spaced apart from each other.

The above summary of the present disclosure is not intended to describe each disclosed embodiment or every implementation of the present invention. The description that follows more particularly exemplifies illustrative embodiments. In several places throughout the application, guidance is provided through lists of examples, which examples can be used in various combinations. In each instance, the recited list serves only as a representative group and should not be interpreted as an exhaustive list.

### BRIEF DESCRIPTION OF THE DRAWINGS

The invention may be more completely understood in consideration of the following detailed description in connection with the following figures. The figures are not necessarily drawn to scale. Like numbers used in the figures refer to like components. However, it will be understood that the use of a number to refer to a component in a given figure is not intended to limit the component in another figure labeled with the same number.

FIG. 1 is a plan view of an adhesive layer for an adherable film as known in prior art;

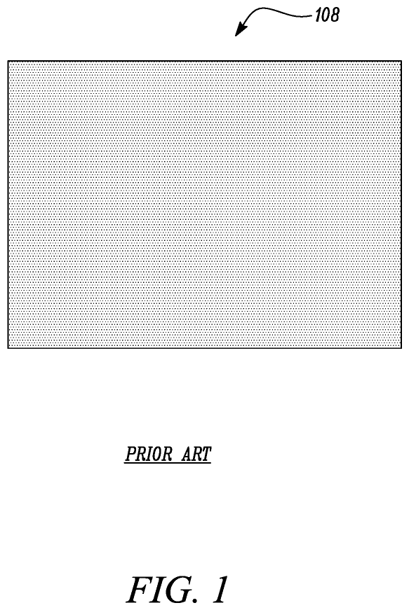

FIG. 2 is a plan view of another adhesive layer for the adherable film as known in prior art;

FIG. 3 is a perspective view of an adherable film as per present invention;

FIG. 4 is a plan view of an adhesive layer for the adherable film;

FIG. 5 is a plan view of another adhesive layer for the adherable film;

FIG. 6 is a plan view of another adhesive layer for the adherable film;

FIG. 7 is a plan view of another adhesive layer for the adherable film; and

FIG. 8 is a flowchart depicting a method of manufacturing for the adherable film.

### DETAILED DESCRIPTION

In the following description, reference is made to the accompanying figures that form a part thereof and in which various embodiments are shown by way of illustration. It is to be understood that other embodiments are contemplated and may be made without departing from the scope or spirit of the present disclosure. The following detailed description, therefore, is not to be taken in a limiting sense.

As recited herein, all numbers should be considered modified by the term “about”. As used herein, “a,” “an,” “the,” “at least one,” and “one or more” are used interchangeably.

As used herein as a modifier to a property or attribute, the term “generally”, unless otherwise specifically defined, means that the property or attribute would be readily recognizable by a person of ordinary skill but without requiring absolute precision or a perfect match (e.g., within +/−20% for quantifiable properties).

The term “substantially”, unless otherwise specifically defined, means to a high degree of approximation (e.g., within +/−10% for quantifiable properties) but again without requiring absolute precision or a perfect match. Terms such as same, equal, uniform, constant, strictly, and the like, are understood to be within the usual tolerances or measuring error applicable to the particular circumstance rather than requiring absolute precision or a perfect match.

In the context of the present disclosure, “a continuous pattern” refers to a pattern having an interconnected structure without any discontinuities.

As used herein, a component or a material (e.g., substrate or an adhesive) that is substantially free of a flame retardant material does not include an effective amount of the flame retardant material. The material may include (either in a coating layer on the surface of or mixed in the bulk of the material) less than a sufficient level of flame retardant material for improving the flame retardance of the material, e.g., the material may include less than 1%, or less than 0.5%, or 0% by weight of the flame retardant material.

The present disclosure relates to an adherable film including a substrate having a top major surface and a bottom major surface. The substrate is substantially free of a flame retardant material. The adherable film includes an adhesive layer disposed on the bottom major surface of the substrate and having a continuous pattern. The adhesive layer is made of an adhesive that is substantially free of a flame retardant material. In a plan view, the continuous pattern defines a plurality of discontinuous non-adhesive portions of the substrate without the adhesive. Each discontinuous non-adhesive portion is completely surrounded by the continuous pattern.

The discontinuous non-adhesive portions are separated from each other by the continuous pattern of the adhesive. The separation between the non-adhesive portions may slow the progress of a flame. Consequently, the adherable film with the continuous pattern may exhibit improved flame retarding characteristic relative to a conventional adherable film having a similar substrate and a similar amount and type of adhesive with a discontinuous adhesive pattern. The continuous pattern may also provide easy handling and good adhesive properties. Further, the flame retardance of the adherable film may be improved while maintaining good adhesive tack and peel.

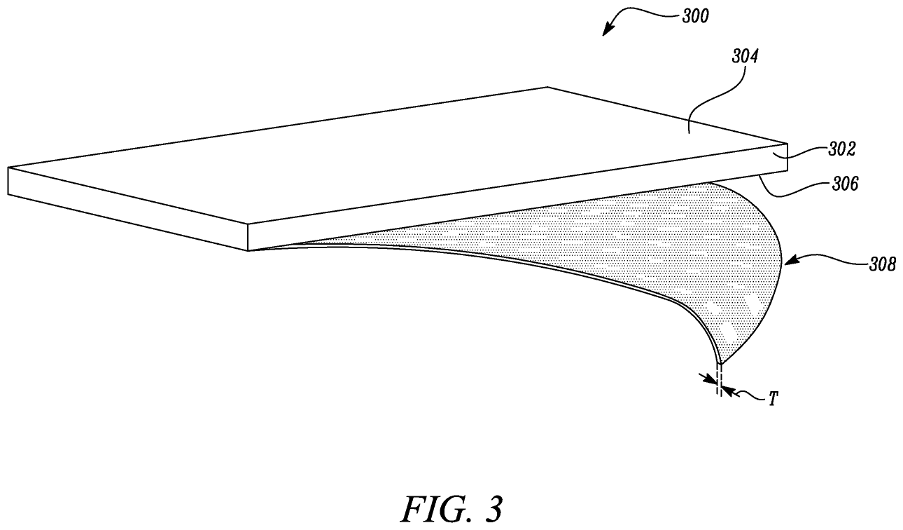

FIG. 3 illustrates an adherable film 300 according to the present invention. The adherable film 300 may be applied to surfaces in interior or exterior of a building such as a hotel, a school, a hospital or a restaurant. The adherable film 300 may also be applied to a vehicle, such as a train, an automobile or an aircraft. The adherable film 300 may be used in various other applications and the examples provided herein are not limiting in any manner.

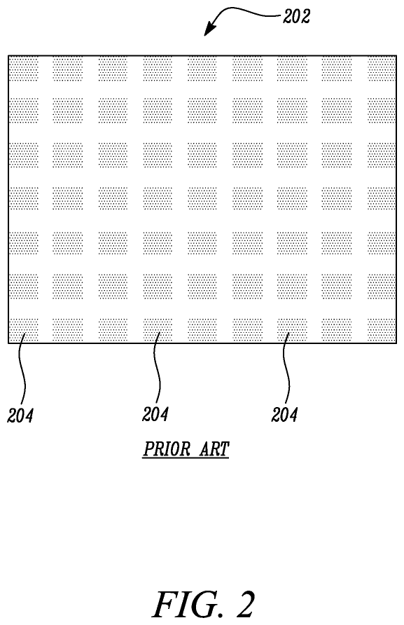

The adherable film 300 includes a substrate 302. The substrate 302 includes polyesters, polyurethanes, polyolefins, polyvinyl chlorides and copolymers thereof. The substrate 302 may include any other suitable material. The substrate 302 has a top major surface 304 and a bottom major surface 306. The substrate 302 is substantially free of a flame retardant material. The adherable film 300 further includes an adhesive layer 308. The adhesive layer 300 may include any type of an adhesive material such as an acrylate, a pressure sensitive adhesive, a stretch release adhesive, an adhesive foam etc. The present disclosure is not limited by type of adhesive in any manner. The adhesive layer 308 is disposed on the bottom major surface 306 of the substrate 302. The adhesive layer 308 has a same mass of the adhesive as that of the discontinuous adhesive layer 202, shown in FIG. 2. Also, the substrate 302 of the adhesive layer 308 has a same material composition as that of the substrate 102 of the discontinuous adhesive layer 202. Further, a thickness T of the adhesive layer 308 is from about 12.7 microns to about 76.2 microns. The thickness T of the adhesive layer 308 may vary as per application requirements.

There are a plurality of parameters to measure flame retardant characteristics of the adherable film 300. One, several, or all of these parameters may be considered by the designer or the customer in deciding whether such an adherable film is suitable for a given application. The flame retarding characteristic of the adherable film 300 is defined based on at least one of a total heat release (THR), a peak heat release rate (HRR) and a fire growth rate (FIGRA). THR refers to total amount of heat released during combusting or burning of a material. A higher THR corresponds to a material having lower flame retardant characteristics, since high THR may lead to fire spreading to other materials with lower temperature thresholds for combustion and/or ignition. Similarly, a lower THR corresponds to a material having higher flame retardant characteristics as the fire may be more likely to be contained. HRR is a measure of the rate at which heat energy is emitted by a material when burned. HRR is expressed in terms of power per unit area (kW/m2). Peak HRR occurs when the material is burning most vigorously. Similar to a high THR, a higher HRR corresponds to a material having lower flame retardant characteristics. And, a lower HRR corresponds to a material having higher flame retardant characteristics. FIGRA is defined as growth rate of the burning intensity, i.e., the HRR during a test such as a single burning item test. FIGRA is expressed in terms of W/s. For similar safety reasons, a higher FIGRA corresponds to a material with lower flame retardant characteristics. And, a lower higher FIGRA corresponds to a material with higher flame retardant characteristics.

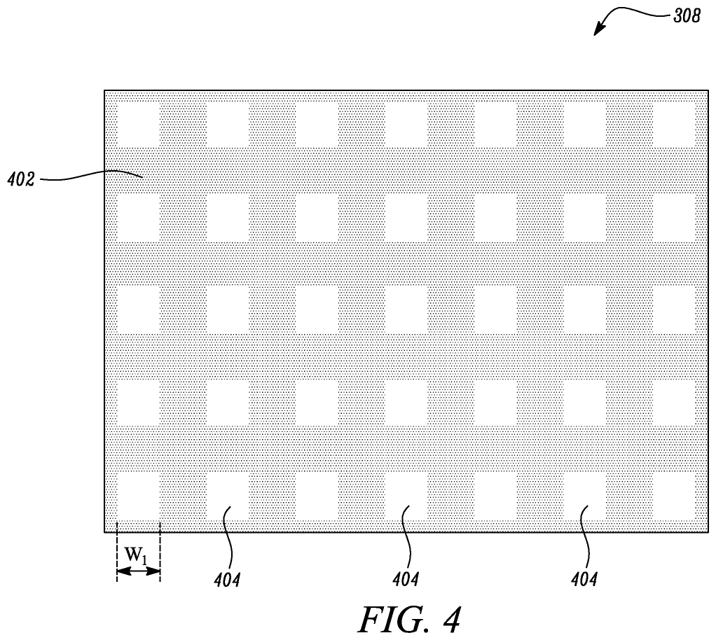

FIG. 4 illustrates a plan view of the adhesive layer 308. The adhesive layer 308 has a continuous pattern 402. The continuous pattern 402 covers at least 50% of a total area of the bottom major surface 306 of the substrate 302. The continuous pattern 402 defines a plurality of discontinuous non-adhesive portions 404 of the substrate 302 without the adhesive. Each discontinuous non-adhesive portion 404 is completely surrounded by the continuous pattern 402.

The discontinuous non-adhesive portions 404 may have any suitable shape as per application requirements. In this embodiment, each discontinuous non-adhesive portion 404 has a square shape as illustrated in FIG. 4. In some embodiments, some of the discontinuous non-adhesive portions may have different shapes. A width W₁ of each discontinuous non-adhesive portion 404 is greater than or equal to 0.5 mm and less than or equal to 1 cm. The width W₁ of the discontinuous non-adhesive portion 404 may vary based on application requirements. It is observed based on experimental results that as the width W₁ of the discontinuous non-adhesive portion 404 decreases, and the number of discontinuous non-adhesive portion 404 increase for a given area, the flame retardant characteristics of the adherable film 300 improves. Some or each discontinuous non-adhesive portion 404 may have a polygonal shape. Further, some or each discontinuous non-adhesive portion 404 may have a same area. In the embodiment of FIG. 4, each discontinuous non-adhesive portion 404 has a rectangular shape.

In some cases, the adherable film 300 may be formed by cutting a section from a large web including the substrate 302 and the adhesive layer 308. In such cases, some of the non-adhesive portions 404 may be disposed at one or more edges of the adherable film 300. In other words, one or more edges of the adherable film 300 may at least partly define some of the non-adhesive portions 404. However, the non-adhesive portions 404 at the edges may still be separated from each other by the continuous pattern 402. Therefore, a flame retarding characteristic of the adherable film 300 is not measurably affected.

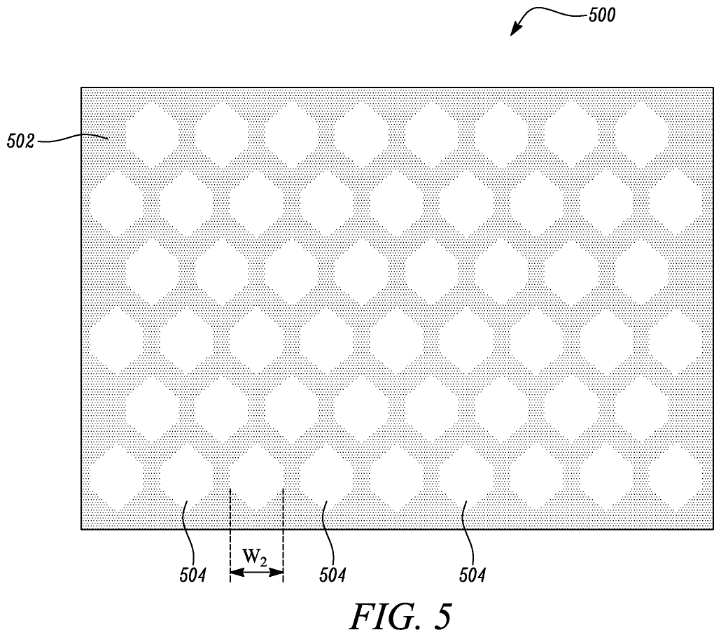

FIG. 5 illustrates another adhesive layer 500 in a plan view with a different shape for the continuous pattern and for the discontinuous non-adhesive portions. The adhesive layer 500 has a continuous pattern 502. The continuous pattern 502 covers at least 50% of a total area of the bottom major surface 306 of the substrate 302. The continuous pattern 502 defines a plurality of discontinuous non-adhesive portions 504 of the substrate 302 without the adhesive. Each discontinuous non-adhesive portion 504 is completely surrounded by the continuous pattern 502.

A width W₂ of each discontinuous non-adhesive portion 504 is greater than or equal to 0.5 mm and less than or equal to 1 cm. The width W₂ of discontinuous non-adhesive portion 504 may vary based on application requirements. It is observed based on experimental results that as the width W₂ of the discontinuous non-adhesive portion 504 decreases, and the number of discontinuous non-adhesive portions 504 increase for a given area, the flame retardant characteristics of the adherable film 300 improves. Each discontinuous non-adhesive portion 504 has a polygonal shape. Further, each discontinuous non-adhesive portion 504 has a same area. The discontinuous non-adhesive portions 504 may have any suitable shape as per application requirements. Each discontinuous non-adhesive portion 504 may have a hexagonal or, overall, a honeycomb shape, as illustrated in FIG. 5.

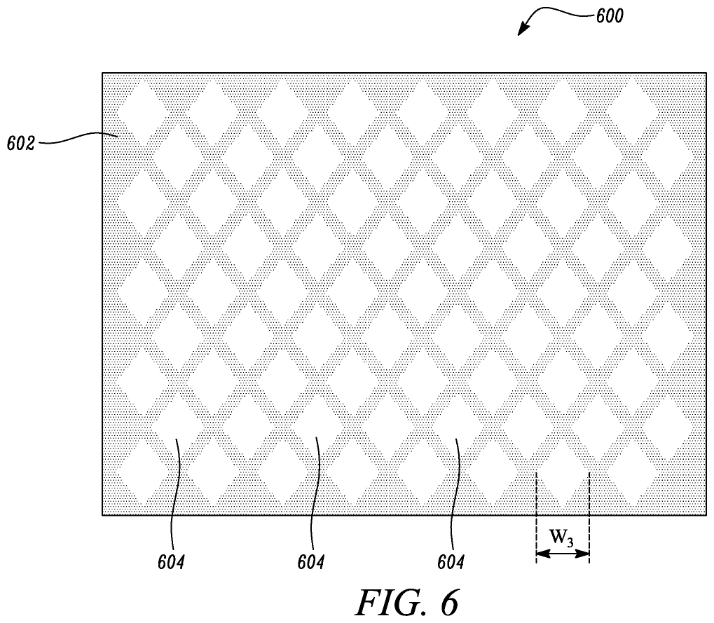

FIG. 6 illustrates another adhesive layer 600 in a plan view with a different shape for the continuous pattern and for the discontinuous non-adhesive portions. The adhesive layer 600 has a continuous pattern 602. The continuous pattern 602 covers at least 50% of a total area of the bottom major surface 306 of the substrate 302. The continuous pattern 602 defines a plurality of discontinuous non-adhesive portions 604 of the substrate 302 without the adhesive. Each discontinuous non-adhesive portion 604 is completely surrounded by the continuous pattern 602.

The discontinuous non-adhesive portions 604 may have any suitable shape as per application requirements. Each discontinuous non-adhesive portion 604 has a rhomboidal or parallelogram shape as illustrated in FIG. 6. A width W3 of each discontinuous non-adhesive portion 604 is greater than or equal to 0.5 mm and less than or equal to 1 cm. The width W₃ of discontinuous non-adhesive portion 604 may vary based on application requirements. It is observed based on experimental results that as the width W₃ of the discontinuous non-adhesive portions 604 decreases, and the number of discontinuous non-adhesive portion 604 increase for a given area, the flame retardant characteristics of the adherable film 300 improves. Each discontinuous non-adhesive portion 604 has a polygonal shape. Further, each discontinuous non-adhesive portion 604 has a same area.

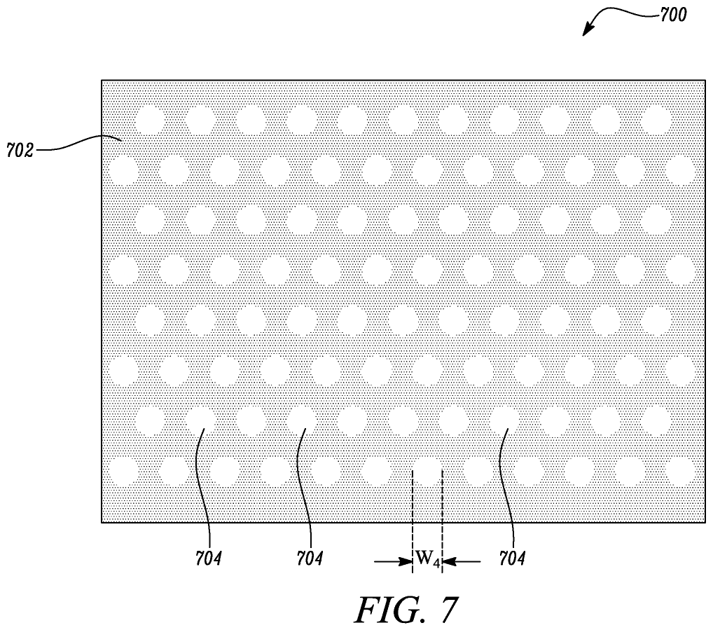

FIG. 7 illustrates another adhesive layer 700 in a plan view with a different shape for the continuous pattern and for the discontinuous non-adhesive portions. The adhesive layer 700 has a continuous pattern 702. The continuous pattern 702 covers at least 50% of a total area of the bottom major surface 306 of the substrate 302. The continuous pattern 702 defines a plurality of discontinuous non-adhesive portions 704 of the substrate 302 without the adhesive. Each discontinuous non-adhesive portion 704 is completely surrounded by the continuous pattern 702.

The discontinuous non-adhesive portions 704 may have any suitable shape as per application requirements. Each discontinuous non-adhesive portion 704 has a circular shape as illustrated in FIG. 7. A width W₄ of each discontinuous non-adhesive portion 704 is greater than or equal to 0.5 mm and less than or equal to 1 cm. As the discontinuous non-adhesive portion 704 are circular in shape, the width W₄ may also be referred to as a dimeter of the discontinuous non-adhesive portion 704. The width W₄ of discontinuous non-adhesive portion 704 may vary based on application requirements. It is observed based on experimental results that as the width W₄ of the discontinuous non-adhesive portion 704 decreases, and the number of discontinuous non-adhesive portions 704 increase for a given area, the flame retardant characteristics of the adherable film 300 improves. Further, each discontinuous non-adhesive portion 704 has a same area.

The discontinuous non-adhesive portions 404, 504, 604, 704 may have any suitable shape in addition to the exemplary embodiments illustrated. In some embodiments, the shape or size of some or all of the discontinuous non-adhesive portions 404, 504, 604, 704 may vary across one or more dimensions of the adherable film. For example, the non-adhesive portions 404, 504, 604, 704 may increase in area, may decrease in area, or may increase and then decrease in area, when moving from one edge of the adherable film to an opposite edge. However, in all such embodiments, each of the discontinuous non-adhesive portion will be completely surrounded by the respective continuous pattern 402, 502, 602, 702.

Various patterns of the adhesive layer 308 may provide different results with the parameters to measure the flame retarding characteristic. However, it is observed that if the discontinuous non-adhesive portions 404, 504, 604, 704 are completely surrounded by the respective continuous pattern 402, 502, 602, 702, the flame retarding characteristic is improved as compared to conventional adherable films where such non-adhesive portions are not surrounded. The total HRR for the adherable film with the adhesive layer 308 with the continuous pattern 402, 502, 602, 702 may be less than or equal to 8.0 MJ/m². The THR of the adherable film 300 with the continuous pattern 402, 502, 602, 702 may be lower than a THR of the adherable film 100 with the discontinuous adhesive layer 202.The peak HRR of the adherable film 300 with the continuous pattern 402, 502, 602, 702 may be lower than a peak HRR of the adherable film 100 with the discontinuous adhesive layer 202. Also, the FIGRA of the adherable film 300 with the continuous pattern 402, 502, 602, 702 may be lower than a FIGRA of the adherable film 100 with the discontinuous adhesive layer 202.

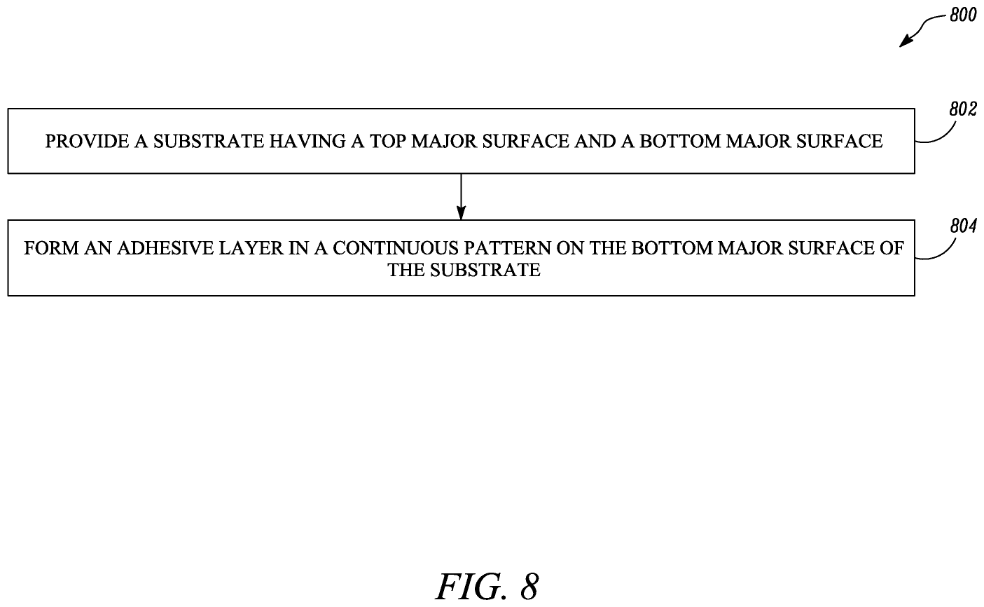

Referring to FIG. 8, the present disclosure further provides a method 800 of manufacturing the adherable film 300. At step 802, the method 800 includes providing the substrate 302 having the top major surface 304 and the bottom major surface 306. The substrate 302 is substantially free of the flame retardant material. The substrate 302 may include polyesters, polyurethanes, polyolefins, polyvinyl chlorides, and/or blends and copolymers thereof. At step 804, the method 800 further includes forming the adhesive layer 308 in the continuous pattern 402, 502, 602, 702 on the bottom major surface 306 of the substrate 302. The formation of the adhesive layer may include one or more printing, coating, depositing, or masking steps. The thickness T of the adhesive layer 308 is from about 12.7 microns to about 76.2 microns. The adhesive layer 308 is made of an adhesive that is substantially free of a flame retardant material. Further, the continuous pattern 402, 502, 602, 702 covers at least 50% of a total area of the bottom major surface 306 of the substrate 302.

In a plan view, the continuous pattern 402, 502, 602, 702 defines the plurality of discontinuous non-adhesive portions 404, 504, 604, 704 of the substrate 302 without the adhesive. In some embodiments, the width of each discontinuous non-adhesive portion 404, 504, 604, 704 is greater than or equal to 0.5 mm and less than or equal to 1 cm. Each discontinuous non-adhesive portion 404, 504, 604, 704 is completely surrounded by the respective continuous pattern 402, 502, 602, 702. Further, the adherable film with the adhesive layer 308 having the continuous pattern 402, 502, 602, 702 exhibits an improved flame retarding characteristic relative to the adherable film 100 with the discontinuous adhesive layer 202 having the substrate 102 with a same material composition as that of the substrate 302 of the adherable film 300 and the discontinuous adhesive layer 202 with a same material composition as that of the adhesive layer 308 of the adherable film 300. This is the case even though the discontinuous adhesive layer 202 has a same mass of the adhesive as that of the adhesive layer 308 of the adherable film 300 and has the plurality of discontinuous adhesive portions 204 spaced apart from each other.

Further, the flame retarding characteristics are improved without decreasing the material of the substrate and quantity of adhesive being used. Due to this, overall handling and adhesive properties of the adherable film 300 are retained.

A cone calorimeter ISO 5660 is a test which is used to correlate to a real time fire situation. ISO 5660-1:2015 specifies a method for assessing the heat release rate and dynamic smoke production rate of specimens exposed in the horizontal orientation to controlled levels of irradiance with an external igniter. The heat release rate is determined by measurement of the oxygen consumption derived from the oxygen concentration and the flow rate in the combustion product stream. The time to ignition (sustained flaming) is also measured in this test.

Experimental data for various types of patterns and sizes are provided in Table 1 below.

TABLE 1
Heat Release Data

| | THR | Peak HRR | | THR after 20 min |
|---|---|---|---|---|
| Variant | (MJ/m²) | (kW/m²) | FIGRA | (MJ/m²) |
| 2 × 2 Square | 3.8 | 181 | 8.2 | 9.4 |
| 2 × 2 Border | 3.4 | 133 | 6.7 | 8.9 |
| 6 × 6 Square | 3.8 | 190 | 7.9 | 10.5 |
| 6 × 6 Border | 3.1 | 133 | 6.0 | 8.4 |

Adherable films were tested with various configurations of the adhesive pattern.

Referring to Table 1, first row includes data for a 2×2 square, which refers to four adhesive squares arranged in a 2×2 pattern. Such a pattern with adhesive regions surrounded by non-adhesive regions may be referred to as a window pattern. Third row includes data for a similar pattern with 36 squares arranged in a 6×6 pattern. Second row includes data for 2×2 border, which refers to four non-adhesive squares in 2×2 pattern provided with a continuous adhesive border. Such a pattern with non-adhesive regions surrounded by adhesive borders is referred to as a border pattern. Fourth row includes data for a similar pattern with 36 non-adhesive square regions arranged in a 6×6 pattern and surrounded by a continuous adhesive border. It may be observed that reducing size of non-adhesive squares and increasing the number of non-adhesive squares, while keeping the total adhesive content constant, improves certain flame retarding characteristics. Also, border pattern (i.e., patterns where non-adhesive portions are completely surrounded by a continuous adhesive pattern) exhibits better flame retarding characteristics as compared to a window pattern (where the adhesive portions are discontinuously placed).

Unless otherwise indicated, all numbers expressing feature sizes, amounts, and physical properties used in the specification and claims are to be understood as being modified by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

We claim:

1. An adherable film, comprising:
a substrate having a top major surface and a bottom major surface, wherein the substrate is substantially free of a flame retardant material;
an adhesive layer disposed on the bottom major surface of the substrate and having a continuous pattern, wherein the adhesive layer is made of an adhesive that is substantially free of a flame retardant material,
wherein, in a plan view, the continuous pattern defines a plurality of discontinuous non-adhesive portions of the substrate without the adhesive, wherein each discontinuous non-adhesive portion is completely surrounded by the continuous pattern, and
wherein the adherable film including the adhesive layer having the continuous pattern exhibits an improved flame retarding characteristic relative to a discontinuous adherable film having a substrate with a same material composition as that of the substrate of the adherable film and a discontinuous adhesive layer with a same material composition as that of the adhesive layer of the adherable film, the discontinuous adhesive layer having a same mass of the adhesive as that of the adhesive layer of the adherable film and having a plurality of discontinuous adhesive portions spaced apart from each other.

2. The adherable film of claim 1, wherein a total heat release (THR) of the adherable film with the adhesive layer is less than or equal to 8.0 MJ/m².

3. The adherable film of claim 1, wherein the flame retarding characteristic is defined based on at least one of a total heat release (THR), a peak heat release rate (HRR) and a fire growth rate (FIGRA).

4. The adherable film of claim 3, wherein a THR of the adherable film with the continuous pattern is lower than a THR of the discontinuous adherable film.

5. The adherable film of claim 3, wherein a peak HRR of the adherable film with the continuous pattern is lower than a peak HRR of the discontinuous adherable film.

6. The adherable film of claim 3, wherein a FIGRA of the adherable film with the continuous pattern is lower than a FIGRA of the discontinuous adherable film. The adherable film of claim 1, wherein a width of each discontinuous non-adhesive portion is greater than or equal to 0.5 mm and less than or equal to 1 cm.

8. The adherable film of claim 1, wherein a thickness of the adhesive layer is from about 12.7 microns to about 76.2 microns.

9. The adherable film of claim 1, wherein each discontinuous non-adhesive portion has a polygonal shape.

10. The adherable film of claim 1, wherein each discontinuous non-adhesive portion has a same area.

11. The adherable film of claim 9, wherein each discontinuous non-adhesive portion has a square shape.

12. The adherable film of claim 1, wherein the continuous pattern covers at least 50% of a total area of the bottom major surface of the substrate.

13. The adherable film of claim 1, wherein the substrate includes polyesters, polyurethanes, polyolefins, polyvinyl chlorides and copolymers thereof.

14. A method of manufacturing an adherable film, the method comprising:
providing a substrate having a top major surface and a bottom major surface, wherein the substrate is substantially free of a flame retardant material; and
forming an adhesive layer in a continuous pattern on the bottom major surface of the substrate, wherein the adhesive layer is made of an adhesive that is substantially free of a flame retardant material,
wherein, in a plan view, the continuous pattern defines a plurality of discontinuous non-adhesive portions of the substrate without the adhesive, wherein each discontinuous non-adhesive portion is completely surrounded by the continuous pattern, and
wherein the adherable film with the adhesive layer having the pattern exhibits an improved flame retarding characteristic relative to a discontinuous adherable film having a substrate with a same material composition as that of the substrate of the adherable film and a discontinuous adhesive layer with a same material composition as that of the adhesive layer of the adherable film, the discontinuous adhesive layer having a same mass of the adhesive as that of the adhesive layer of the adherable film and having a plurality of discontinuous adhesive portions spaced apart from each other.

15. The method of manufacturing of claim 14, wherein a width of each discontinuous non-adhesive portion is greater than or equal to 0.5 mm and less than or equal to 1 cm.

16. The method of manufacturing of claim 14, wherein a thickness of the adhesive layer is from about 12.7 microns to about 76.2 microns.

17. The method of manufacturing of claim 14, wherein the continuous pattern covers at least 50% of a total area of the bottom major surface of the substrate.

18. The method of manufacturing of claim 14, wherein the substrate includes polyesters, polyurethanes, polyolefins, polyvinyl chlorides and copolymers thereof.

19. An adherable film, comprising:
a substrate having a top major surface and a bottom major surface, wherein the substrate is substantially free of a flame retardant material;
an adhesive layer disposed on the bottom major surface of the substrate and having a continuous pattern, wherein the adhesive layer is made of an adhesive that is substantially free of a flame retardant material,
wherein, in a plan view, the continuous pattern defines a plurality of discontinuous non-adhesive portions of the substrate without the adhesive, wherein each discontinuous non-adhesive portion is completely surrounded by the continuous pattern,
wherein the adherable film with the adhesive layer having the pattern has a lower total heat release rate (THR) relative to a discontinuous adherable film having a substrate with a same material composition as that of the substrate of the adherable film and a discontinuous adhesive layer with a same material composition as that of the adhesive layer of the adherable film, the discontinuous adhesive layer having a same mass of the adhesive as that of the adhesive layer of the adherable film and having a plurality of discontinuous adhesive portions spaced apart from each other.

20. The adherable film of claim 19, wherein a total heat release (THR) of the adhesive layer is less than or equal to 8.0 MJ/m².
